(19) United States
(12) Patent Application Publication
(10) Pub. No.: US 2025/0021053 A1
(43) Pub. Date: Jan. 16, 2025

(54) WATCH THAT CAN BE WORN AROUND THE NECK

(71) Applicant: Porsche Lifestyle GmbH & Co. KG, Ludwigsburg (DE)

(72) Inventor: Manuel Röck, Stuttgart (DE)

(73) Assignee: Porsche Lifestyle GmbH & Co. KG, Ludwigsburg (DE)

(21) Appl. No.: 18/770,874

(22) Filed: Jul. 12, 2024

(30) Foreign Application Priority Data
Jul. 13, 2023 (DE) 10 2023 118 612.4

(51) Int. Cl. G04B 37/14

(52) U.S. Cl. CPC G04B 37/14

(57) ABSTRACT

A watch for time measurement is provided with a watch housing for housing a time measuring unit, a connecting element attached to the watch case, and a lanyard connected to the connecting element for wearing around a neck of a person. A loop size of the lanyard engaging around the neck can be variably adjusted with the aid of an adjusting element engaging on the lanyard. The setting element allows the watch to be held back in a loss-proof manner with a reduced loop size of the lanyard, so that time measurement in a motor vehicle, especially in rally sport, is possible with good driving safety.

### CROSS-REFERENCE TO RELATED APPLICATION

This application claims priority to German Patent Application No. 10 2023 118 612.4, filed Jul. 13, 2023, the content of such application being incorporated by reference herein in its entirety.

### FIELD OF THE INVENTION

The invention relates to a watch which can be worn around a neck and which can be used to measure time.

### BACKGROUND OF THE INVENTION

It is known from CN 218549961 U and DE 201 11 149 U1, which are both incorporated by reference herein, to replace a wristwatch strap with a lanyard so that the wristwatch can be worn around the neck.

A watch that can be worn around the neck is ideal for a co-driver in rallying to announce lap times and/or time-relevant information for cornering and/or special stages. There is a constant need to improve driving safety and prevent injuries and/or accidents, especially in motorsport rallies.

### SUMMARY OF THE INVENTION

Described herein is a watch that enable time measurement in a motor vehicle with good driving safety. Preferably, the watch may be suitable for rally sport.

One aspect of the invention relates to a watch for time measurement, comprising a watch housing for housing a time measurement unit, a connecting element attached to the watch housing, and a lanyard connected to the connecting element for wearing around a neck of a person, wherein a loop size of the lanyard engaging around the neck can be variably adjusted by means of an adjusting element engaging the lanyard.

A sporty and high-performance driving style, especially in rally sport, can result in high acceleration forces on the vehicle occupants. When cornering, acceleration forces can occur in the transverse direction (Y direction), while acceleration forces can occur in the longitudinal direction (X direction) during strong acceleration and braking. It is even possible for acceleration forces to occur in the direction of gravity (Z direction), for example if the vehicle drives over a hill crest at high speed and lifts off the ground. It was recognized that acceleration forces in the direction of gravity can cause a watch hanging around the neck to lift off, so that there is a risk that the watch could detach itself from the wearer's head. The detached watch can then cause damage to the vehicle or be damaged itself. In particular, there is a risk that the driver will be disturbed and distracted by the detached watch, which could lead to an accident.

However, the loop size of the lanyard can be changed using the adjustment element. The adjustment element can initially enable a very large loop size so that the lanyard can be easily passed over the wearer's head. Once the lanyard has reached the wearer's neck, the loop size of the lanyard can be reduced using the adjustment element. In particular, the loop size of the lanyard is reduced so that the loop size is larger than the neck circumference but smaller than the head circumference. If the watch should lift off the wearer in the event of acceleration forces in the direction of gravity, the reduced loop size means that the lanyard can be retained on the wearer's chin and cannot be thrown through the vehicle interior. The setting element allows the watch to be held back in a loss-proof manner with a reduced loop size of the lanyard, so that time measurement in a motor vehicle, especially in rally sport, is possible with good driving safety.

The time measuring unit of the watch can be designed to display the current time. In particular, the time measuring unit can fulfill the typical functions of a wristwatch. Preferably, the time measuring unit has a stopwatch function. The time measuring unit can be based on mechanical principles for measuring time, wherein the time measuring unit has, in particular, a mechanical movement whose energy source for operating the movement can also be designed mechanically, for example a balance and/or a wound spring, wherein the energy source can additionally or alternatively also be designed electrically, for example with the aid of a battery. Preferably, the time measuring unit is designed as an electronic unit, in particular as a smart watch.

The watch housing is designed in particular for mechanical protection of the time measuring unit. Preferably, the watch housing is additionally or alternatively designed to protect the time measuring unit from environmental influences, for example moisture, dust and/or wetness. It is possible for the watch housing to completely enclose the time measuring unit, wherein the watch housing in particular has a substantially transparent window in order to be able to see the displays of the time measuring unit. If the time measuring unit has its own display, it is also possible to use the display itself as part of the outer casing of the watch.

The lanyard can be designed as a cord, for example. In particular, the cord can be braided from several fibers. Preferably, the cord has a diameter of approx. 3 mm to 5 mm. In particular, it is possible for the lanyard to have an essentially circular cross-section, wherein it is also possible for the lanyard to have an essentially rectangular cross-section. In particular, the lanyard can be made of a plastic material. For example, the lanyard has a total extension of approx. 90 cm ±10 cm. The maximum loop size of the lanyard can therefore be approx. 45 cm ±5 cm.

In particular, the connecting element can be attached to the watch housing at a point where a strap would otherwise be attached to the watch housing. In relation to the display of the time measuring unit, the connecting element can be provided at a 12 o'clock position and/or or at a 3 o'clock position and/or a 6 o'clock position and/or a 9 o'clock position. Preferably, the time measuring unit can be clamped in the watch housing so that it can be rotated by hand, so that a desired relative alignment of the display of the time measuring unit to the connecting element, in particular only one, can be set individually. At the same time, the connecting element enables a connection with the lanyard. For example, the connecting element can be tied and/or knotted to the connecting element. However, it is also possible for the connecting element to form a detachable or non-detachable attachment to the lanyard, for example by clamping and/or crimping. Preferably, the connection between the lanyard and the connecting element can be designed such that a relative movement of the watch case along the longitudinal extension of the lanyard is blocked by friction and/or positive locking.

In particular, the adjusting element is frictionally fixed to the lanyard. The frictional force applied can be overcome by hand in order to be able to move the adjusting element along the lanyard and thereby adjust the loop circumference. For example, the loop size of the lanyard can be maximized in order to secure the lanyard to the connecting element, in particular a knot. The friction fit can prevent the adjusting element from falling off. In particular, the adjusting element can enclose at least part of the lanyard so that the adjusting element is positively secured in a loss-proof manner to the lanyard.

Preferably, the adjusting element encompasses two strap sections of the lanyard arranged next to each other. One strap section can be a part of the lanyard leading to the connecting element and the other strap section can be a part of the lanyard coming from the connecting element. As a result, the adjusting element can limit a loop fastened with the connecting element and a material loop fastened with a neck, the respective loop size of which can be changed by moving the adjusting element along the two strap sections. This makes it possible to easily and intuitively adjust the loop size of the lanyard intended for the neck.

It is particularly preferred that the lanyard has at least one fixed stopper to limit the loop size, which can be adjusted using the adjustment element, to a predefined minimum size. The adjusting element, which can be moved relative to the lanyard, can strike the immovable stopper so that the loop size cannot fall below the minimum size defined with the aid of the stopper. This prevents the loop size from being set too tight due to an error when operating the adjustment element, which could lead to breathing difficulties for the wearer. This improves the operating safety. The minimum size for the loop size intended for the neck can be 30 cm, 35 cm or 40 cm, for example. The stopper can be designed as a knot in the lanyard, for example. The stopper can also be designed as a stop element attached to a predefined position to prevent movement. As the stopper can prevent strangulation, it is possible in particular to avoid a predetermined breaking point on the lanyard, for example by using a plug connection that can be automatically released under load. This prevents the lanyard from opening unnecessarily and/or unintentionally under the accelerations that occur in rally sport and only triggers dangerous situations when the lanyard opens automatically.

In particular, the adjusting element is part of a zip fastener formed with the aid of the lanyard. When the zip is pulled open, a larger loop size is set and when the zip is pulled closed, a smaller loop size is set. In addition, a predefined minimum size for the loop size can be specified via the length of the zip.

Preferably, the connecting element is hinged to the watch housing. This means that it is not necessary to lift the lanyard to read the watch. Handling is simplified as a result.

The connecting element is particularly preferably made of titanium and/or a titanium alloy and/or coated. This enables a high wear resistance and corrosion resistance of the connecting element, so that sliding and/or grinding of the lanyard along the connecting element has no expected influence on the mechanical and/or optical properties of the connecting element. This can improve the service life.

In particular, the connecting element is designed as an eyelet or as a mechanical fastening, especially a clip fastening element. The lanyard can be passed through the eyelet and/or knotted to the eyelet. If the connecting element is designed as a mechanical fastening, the connecting element can be connected to a correspondingly designed fastening partner, preferably one that is resistant to movement. For example, the connecting element can be clipped or screwed or jammed or clamped to the lanyard.

Preferably, a width of the watch housing tapers towards the connecting element and the connecting element is laterally beveled and/or curved to integrate the shape of the connecting element into the shape of the watch housing. The connecting element can thus be integrated into the design language of the watch housing and does not appear to be a foreign element of the watch. Instead, the result is a harmonious appearance that creates a good visual impression.

Particularly preferably, the lanyard is designed as a flat strap. The hanging band can therefore take the form of a lanyard, also known as a “lanyard” or “keylace”. The flat design of the lanyard allows it to lie flat against the wearer's body so that the watch does not get in the way when it is not needed.

In addition, labelling and/or a symbol can be provided on the adjusting element and/or on the connecting element, preferably by laser engraving. This can at least symbolically indicate that the loop size can be adjusted with the aid of the adjusting element. This facilitates handling and correct use of the setting element.

A further aspect relates to the use of the watch, which can be designed and further developed as described above, for rally sport, in particular for time measurement for special stages. The setting element allows the watch to be held back in a loss-proof manner with a reduced loop size of the lanyard, so that time measurement in a motor vehicle in rally sport is possible with good driving safety.

### BRIEF DESCRIPTION OF THE DRAWINGS

The invention will now be described using preferred example embodiments making reference to the accompanying drawings, wherein the features described hereinafter can represent an aspect of the invention both individually and in combination. Shown are:

FIG. 1 is a schematic top view of a first embodiment of a watch, and

FIG. 2 is a schematic detailed view of a second embodiment of the watch.

### DETAILED DESCRIPTION OF THE INVENTION

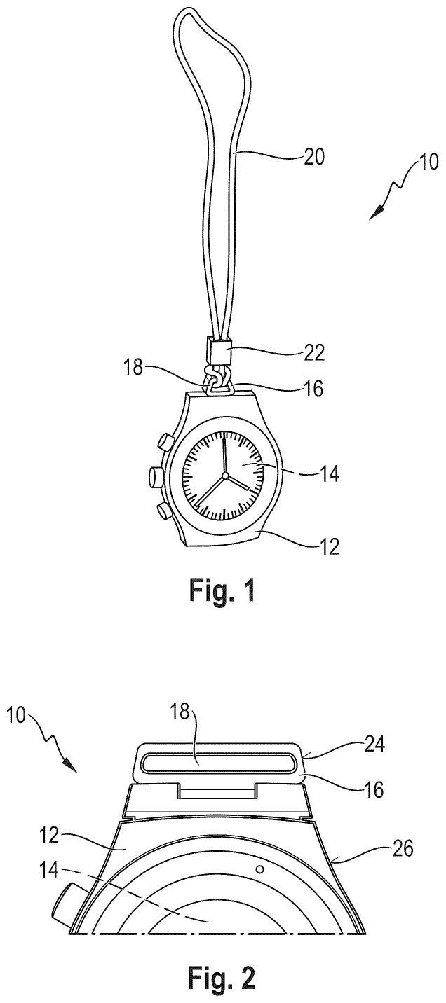

The watch 10 shown in FIG. 1 can be worn around the neck of a co-driver in order to measure the time during a rally in motorsport. The watch 10 has a watch housing 12 in which a time measuring unit 14 is wholly or partially accommodated and/or enclosed. A connecting element 16, which has an eyelet 18, is hingedly attached to one end of the watch housing 12, to which a wristband of a wristwatch can otherwise be attached. The connecting element 16 can be provided at a 12 o'clock position, 3 o'clock position, 6 o'clock position or 9 o'clock position. A lanyard 20 is attached to the eyelet 18, which in the illustrated example embodiment is designed as a cord, knotted to the eyelet 18. An adjusting element 22 is provided in the immediate vicinity of the knot with the eyelet 18, which frictionally engages around the two opposing strap sections of the lanyard 20.

In the position of the adjusting element 22 shown in FIG. 1, the lanyard 20 can be guided around a head of a wearer until the adjusting element 22 arrives at the neck of the wearer. The adjusting element 22 can then be displaced relative to the lanyard 20, so that a loop size of the lanyard 20 on the other side of the adjusting element 22 in the section of the lanyard 20 facing away from the connecting element 16 can be reduced. The loop size can be chosen so small that the watch 10 cannot slip off the head on its own, but is held in a loss-proof manner on the wearer's chin. A minimum loop size can be ensured with the aid of a stopper not shown.

In the example embodiment of the watch 10 shown in FIG. 2, the eyelet 18 of the connecting element 16 is significantly wider compared to the example embodiment of the watch 10 shown in FIG. 1, so that a flat lanyard 20 with an essentially rectangular cross-section can be used as the lanyard 20 instead of a cord with a round cross-section. The connecting element 18 has a width and a lateral outer contour 24 such that a lateral line 26 of the watch case 12 is continued in the outer contour 24 of the connecting element 16. In particular, the watch housing 12 and the connecting element 16 are made of the same material and/or coated with the same material, for example titanium or titanium alloy, so that a harmonious unit with a visually pleasing design language is created.

What is claimed is:

1. A watch for time measurement, said watch comprising:
a watch housing for housing a time measuring unit,
a connecting element attached to the watch housing,
a lanyard connected to the connecting element for wearing around a neck of a user, and
an adjusting element engaged with the lanyard, wherein the adjustment element is configured to adjust a loop size of the lanyard surrounding the neck.

2. The watch according to claim 1, wherein the adjusting element is frictionally mounted to the lanyard.

3. The watch according to claim 1, wherein the adjusting element embraces two strap sections of the lanyard arranged next to each other.

4. The watch according to claim 1, wherein the lanyard has at least one stopper fixed in a motion-proof manner for limiting the loop size, which stopper is configured to be adjusted with the aid of the adjusting element to a predefined minimum size.

5. The watch according to claim 1, wherein the adjusting element is part of a zipper formed by way of the lanyard.

6. The watch according to claim 1, wherein the connecting element is hingedly connected to the watch housing.

7. The watch according to claim 1, wherein the connecting element is composed of titanium and/or a titanium alloy and/or is coated.

8. The watch according to claim 1, wherein the connecting element is either an eyelet or a clip closure element.

9. The watch according to claim 1, wherein a width of the watch case tapers towards the connecting element and the connecting element is laterally beveled and/or curved to integrate a shape of the connecting element into a shape of the watch case.

10. The watch according to claim 1, wherein the lanyard is a flat strap.
